(19) United States
(12) Patent Application Publication
(10) Pub. No.: US 2001/0049618 A1
(43) Pub. Date: Dec. 6, 2001

(54) Method for allocating predictable costs for consumable items

(76) Inventors: Rainer Patzel, Dransfeld (DE); Robert Willard, Coral Springs, FL (US)

Correspondence Address: Andrew V. Smith, Sierra Patent Group, Ltd., P.O. Box 6149, Stateline, NV, 89449, US

(21) Appl. No.: 09/816,677

(22) Filed: Mar. 22, 2001

Related U.S. Application Data
(60) Provisional application No. 60/191,487, filed on Mar. 23, 2000.

(51) Int. Cl. G06F 17/60

(52) U.S. Cl. 705/8

(57) ABSTRACT

Method and system for allocating predictable costs for consumable items of a laser system includes determining an average or predicted lifetime of one or more components of a laser system. Then, costs are estimated for the repair and/or replacement of the components in advance of their predicted failure. The costs are then scheduled to be paid at a known time or known times. The average or predicted lifetime may be determined in terms of time, pulse count, accumulated energy input to the discharge, number of workpieces processed or another countable parameter. Also, the component or components predicted to fail may be ordered in advance for rapid delivery at the time of failure. The components may include a laser tube, tube windows, a line-narrowing optical component, a line-narrowing module, a monitor optics module and a halogen filter, the pulser module for a gas discharge laser and/or containers of laser gas.

### PRIORITY

This application claims priority under 35 USC §119 to provisional application No. 60/191,487 entitled “Method for Allocating Predictable Costs for Consumable Items of a Laser System” filed on Mar. 23, 2000.

### BACKGROUND OF THE INVENTION

1. Field of the Invention

The present invention relates to method and system for providing allocation of costs related to technical and service support for a laser system. More particularly, the present invention relates to method and system for providing an efficient and predictable approach to allocating costs related to consumable items of a laser system in providing technical and field service support to maintain the operation of the laser system.

2. Description of the Related Art

For any types of semiconductor production equipment including excimer laser systems, it is generally important that the equipment provide the most amount of uptime for operation including production, standby and engineering time, reliable operation and ease of maintenance in case of failure and downtime (such as preventive or scheduled maintenance and unscheduled equipment failure) to support the uptime and throughput specifications of the end users. Generally, scheduled maintenance time for the equipment is based on the replacement of equipment modules at the end of their specified lifetime, which, in the case of an excimer laser system, may be based on the pulse count of the laser, and/or the number of hours of operation. Additionally, other important factors for purchasing and operating such equipment include the ability to predictably budget the cost of repair or replacement of parts in the event of equipment failure, as well as lowering such cost.

In the past, consumable components of a laser system would be repaired or replaced, and the costs paid, and possibly the replacement parts ordered, only when the repair or replacement part was needed, i.e., on failure of the consumable component. For example, a component of a lithography laser system such as the laser tube, optics, pulser module, etc. may fail at some unpredictable and undesirable time. At that time, the laser system is shut down until the repair and/or replacement of the failed system component can be made. This unscheduled “downtime” results in lost throughput of processed wafers and lost revenue for the user. It is desired to reduce such downtime.

At the time the component fails, a service engineer is typically called. The engineer diagnoses the problem and either repairs the failed component or orders a replacement component if the failed component cannot be repaired. If the replacement component is not readily on-hand, then a considerable downtime may be incurred before the component is finally delivered. Whether or not a replacement component is ordered, and whether or not the component is readily on-hand for quick replacement, the cost of the repair or replacement are incurred at the time of the repair or replacement, resulting in unpredictable or unbalanced, e.g., quarterly, costs for the user and possibly inconvenient budgetary complexities. It is desired that the costs of such repair or replacement be balanced and predictable, notwithstanding the unpredictable nature of system component failures.

It is therefore an object of the invention to provide a method of allocating predictable costs for consumable items of a laser system that serves to reduce system downtime.

It is a further object of the invention to provide a method whereby predictable costs of repair or replacement of consumable items of a laser system are predictable and balanced, notwithstanding that particular system components may fail anywhere within a range of system usage.

### SUMMARY OF THE INVENTION

In accord with the above objects, a method of allocating predictable costs for consumable items of a laser system is provided in the present invention. The method includes determining an average or predicted lifetime of one or more components of a laser system. Then, costs are estimated for servicing of the components in advance of their predicted failure. The costs are then scheduled to be paid at a known time or known times.

The average or predicted lifetime may be determined in terms of time, pulse count, accumulated energy input to a discharge of the laser system, number of workpieces processed or another countable parameter. Also, the component or components predicted to fail may be ordered in advance for rapid delivery at the time of failure. The components may include the laser tube, resonator optics such as line-narrowing optics, resonator reflectors, tube windows or a line-narrowing module, a monitor optics module, a halogen filter, a pulser module for a gas discharge laser and/or containers of laser gas.

Thus, an end user may purchase repair and/or replacement service and/or parts by paying one time or periodic balanced and predictable costs equal to an amount of time, pulses, workpieces processed, etc., multiplied by a cost per second, pulse, processed workpiece, etc. In addition, the service provider may plan to have parts on-hand in advance of predicted failures, thus reducing system downtimes for the end users.

These and other features and advantages of the present invention will be understood upon consideration of the following detailed description of the invention and the accompanying drawings.

### BRIEF DESCRIPTION OF THE DRAWINGS

FIG. 1 illustrates an overall system for providing global technical and field service support network in accordance with one embodiment of the present invention.

FIG. 2 illustrates a flow chart for providing technical and field service support in the overall system shown in FIG. 1 in accordance with one embodiment of the present invention.

FIG. 3 illustrates a flow chart for providing predictable cost allocation in a laser system in accordance with one embodiment of the present invention.

FIG. 4 illustrates a flow chart for generating a predictable cost allocation schedule for a laser system in accordance with one embodiment of the present invention.

FIG. 5 illustrates a communication network including purchasers of a laser system and the system provider in accordance with one embodiment of the present invention.

FIG. 6 illustrates a laser system component database of FIG. 5 in accordance with one embodiment of the present invention.

FIG. 7 illustrates a cost allocation schedule database of FIG. 5 for a laser system in accordance with one embodiment of the present invention.

FIG. 8 illustrates a customer database of FIG. 5 in accordance with one embodiment of the present invention.

### DETAILED DESCRIPTION

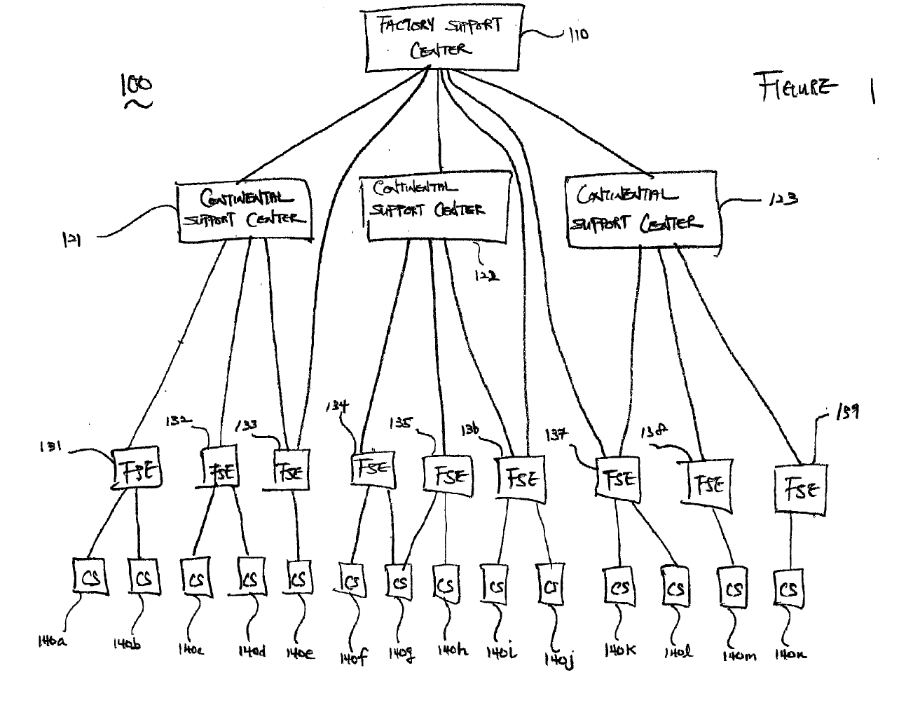

FIG. 1 illustrates an overall system for providing global technical and field service support network in accordance with one embodiment of the present invention. Referring to FIG. 1, the global technical and field service support network 100 includes factory support center (FSC) 110 configured to directly communicate with each of continental support centers (CSCs) 121, 122, 123. Also shown in FIG. 1 are factory service engineers (FSEs) 131, 132, 133, 134, 135, 136, 137, 138, 139, each of whom, as shown, may communicate directly with a corresponding continental support center (CSC), or directly with the factory support center (FSC). Furthermore, each of the customer sites (CSs) 140a, 140b, 140c, 140d, 140e, 140f, 140g, 140h, 140i, 140j, 140k, 140l, 140m as shown may directly communicate with a corresponding on of the factory service engineers (FSEs) 131, 132, 133, 134, 135, 136, 137, 138, 139.

Geographically, factory service engineers (FSEs) 131, 132, 133, 134, 135, 136, 137, 138, 139 may be located in close proximity to the corresponding customer sites (CSs), or in some cases, may actually be on-site at the customer sites (CSs) 140a, 140b, 140c, 140d, 140e, 140f, 140g, 140h, 140i, 140j, 140k, 140l, 140m. Moreover, the continental support centers (CSCs) 121, 122, 123 may be strategically located based on factors such as the density of customer base within a geographic region, the size of customer accounts within a geographic region, and so on.

The factory support center (FSC) 110 may comprise a group of technical experts with direct access to research and development as well as production, who may be available for assistance around the clock. For example, Lamda Physik, the assignee of the present invention, maintains its factory support center (FSC) in Goettingen, Germany. Each of the various continental support centers (CSCs) 121, 122, 123 may include technical experts who are primarily responsible for assisting the field service engineers (FSEs) 131, 132, 133, 134, 135, 136, 137, 138, 139 to quickly diagnose and repair problems arising from the operation and maintenance of the laser systems. As with the factory support center (FSC) 110, the continental support centers (CSCs) 121, 122, 123 may be available 24 hours a day, seven days a week to assist the respective field service engineers (FSEs) 131, 132, 133, 134, 135, 136, 137, 138, 139.

It should be noted that field service engineers (FSEs) 131, 132, 133, 134, 135, 136, 137, 138, 139 are generally responsible for maintaining, diagnosing and repairing the laser systems at the respective customer sites (CSs) 140a, 140b, 140c, 140d, 140e, 140f, 140g, 140h, 140i, 140j, 140k, 140l, 140m.

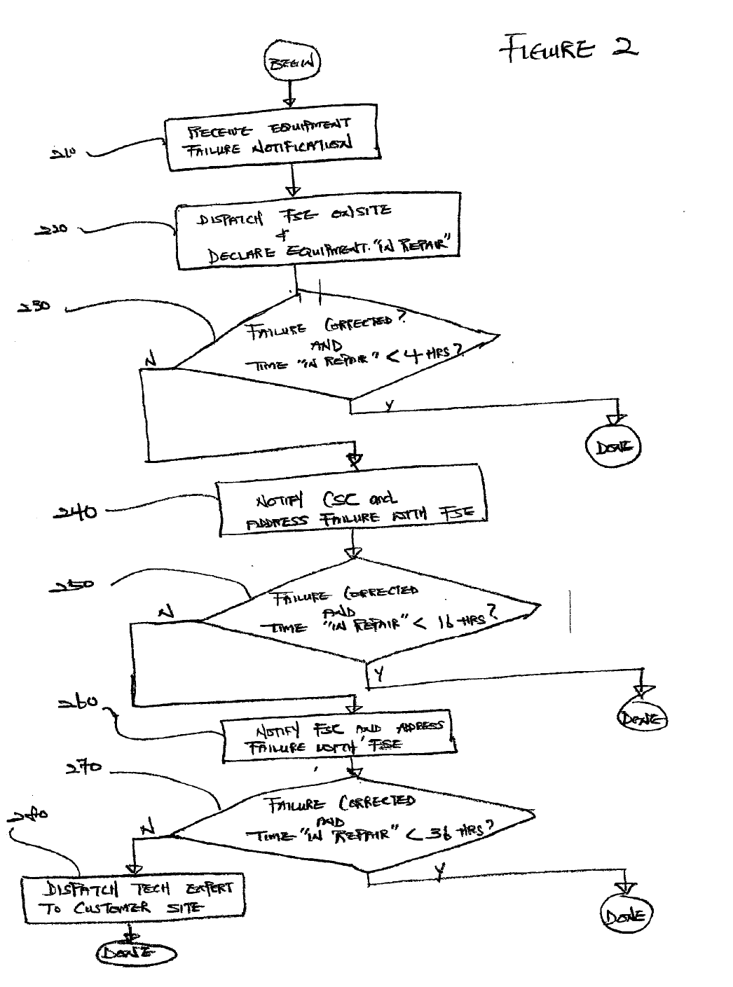

FIG. 2 illustrates a flow chart for providing technical and field service support in the overall system shown in FIG. 1 in accordance with one embodiment of the present invention. Referring to FIG. 2, upon receiving equipment failure notification at a customer site (CS) at step 210, a corresponding field service engineer (FSE) is dispatched to the customer site, and the field service engineer (FSE) declares the customer's laser system “in repair” status at step 220. Thereafter, at step 230, it is determined whether the dispatched field service engineer (FSE) has identified the source of the laser system failure and repaired the laser system within four hours of declaring “in repair” status. If at step 230 it is determined that the field service engineer (FSE) has accurately identified the source of the laser system failure and repaired the system within four hours of declaring “in repair” status, then the procedure terminate.

On the other hand, if at step 230 it is determined that either the field service engineer (FSE) has not corrected the laser system failure and more than four hours has passed since the “in repair” status of the laser system was declared, at step 240, a corresponding continental service center (CSC) is notified and the resident technical experts at the continental service center (CSC) attempts to address the laser system failure, for example, by attempting to identify the source of the system failure, and to provide repair services with the field service engineer (FSE) on site.

Thereafter, at step 250, it is determined whether the technical experts resident at the continental service center (CSC) and the field service engineer (FSE) have properly repaired the failed laser system within 16 hours from the time when the failed laser system was declared to be “in repair” status. If the combined efforts of the technical experts at the continental service center (CSC) and the field service engineer (FSE) have properly addressed the laser system failure within 16 hours from being declared “in repair”, then the procedure terminates. On the other hand, if at step 250 it is determined that even the combined efforts of the technical experts that the continental service center (CSC) and the field service engineer (FSE) were not successful in addressing the customer's laser system failure within 16 hours of declaring “in repair” status, then at step 260, the factory service center (FSC) is notified of the failed laser system, and the technical experts resident at the factory service center (FSC) works directly in conjunction with the field service engineer (FSE) to attempt to isolate the source of the laser system failure and to correct the identified problems to bring the laser system back into operation. Thereafter, at step 270, it is determined whether the combined efforts of the technical experts resident at the factory service center (FSC) and the field service engineer (FSE) successfully isolated the source of the customer's laser system failure and provided repair services to place the laser system in operation within 36 hours of declaring the laser system “in repair” status. If at step 270 it is determined that the combined efforts of the technical experts at the factory service center (FSC) and the on-site field service engineer (FSE) successfully provided repair services to bring the customer's laser system back into operation within the 36 hour window, then the procedure terminates.

On the other hand, if at step 270 it is determined that the combined efforts of the on-site field service engineer (FSE) and the technical experts at the factory service center (FSC) were unsuccessful in providing repair services to the customer's failed laser system within the 36 hour window, then at step 280, a technical expert from the factory service center (FSC) is dispatched to the customer's site for repair services.

In the manner described above, a multi-layered, escalated support service procedure for repair and/or replacement of laser systems and parts thereof, whether for scheduled or unscheduled downtime, it is possible to effectively and efficiently provide repair and/or replacement services for customer's laser systems. Indeed, given the high level of costs involved in deploying technical experts from the factory service center (FSC) on site to the customer's premises, significant cost savings may be provided to the customer of laser systems in the event of equipment failures by implementing the escalated procedure set forth above with a predetermined diagnosis time frame and dedicated field service engineers (FSEs) resident on site or near the customer's site.

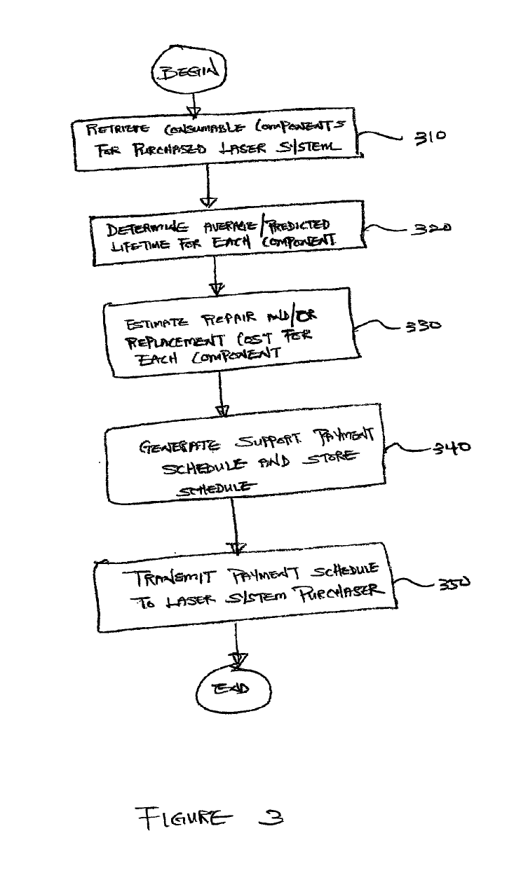

FIG. 3 illustrates a flow chart for providing a predictable cost allocation procedure in the purchase of a laser system in accordance with one embodiment of the present invention. Referring to FIG. 3, at step 310, the consumable components of the purchased laser system is retrieved from a database or other data source. Thereafter at step 320, the average and/or predicted lifetime for each of the consumable components retrieved at step 310 is determined. At step 330, the repair and/or replacement cost for each consumable component for the purchased laser system is determined. In one embodiment, the step of retrieving the average and/or predicted lifetime for each of the consumable components at step 320 and the step of determining the repair and/or replacement cost for each consumable component may be interchangeable such that the step of determining the repair and/or replacement cost for each consumable component may be calculated before the step of determining the average and/or predicted lifetime of each component. Alternatively, in another embodiment, the step of determining the repair and/or replacement cost for each consumable component and the step of retrieving the average and/or predicted lifetime for each consumable component may be performed concurrently.

Referring back to FIG. 3, having retrieved the average and/or predicted lifetime of each consumable component of the purchased laser system at step 320, and having determined the repair and/or replacement cost for each consumable component at step 330, at step 340, a support payment schedule for the purchaser designated support program is generated and stored in a database or memory. Thereafter, at step 350, the generated support payment schedule is transmitted to the purchaser of the laser system.

In one aspect of the present invention, the support payment schedule generated at step 340 and transmitted to the laser system purchaser at step 350 may include a total payment schedule time period (for example, two years), divided into a predetermined payment schedule period (such as every quarter), a predetermined amount for each predetermined payment period, and a total support payment schedule amount, which includes the sum of all of the amount for the predetermined payment periods. Furthermore, in one aspect, the average and/or predicted lifetime for each component of the laser system purchased, and the estimated repair and/or replacement cost for each component may be factored in determining the total support payment schedule amount, as well as the amount for each predetermined payment period. In one embodiment, the amount for each predetermined payment period may be the same for each period of the total payment schedule time period, or alternatively, the amount for the predetermined payment period may vary, depending upon several factors, including but not limited to, the type of use of the laser system, the purchase history of the laser system purchaser, the type of laser system service support program designated by the purchaser, and so on.

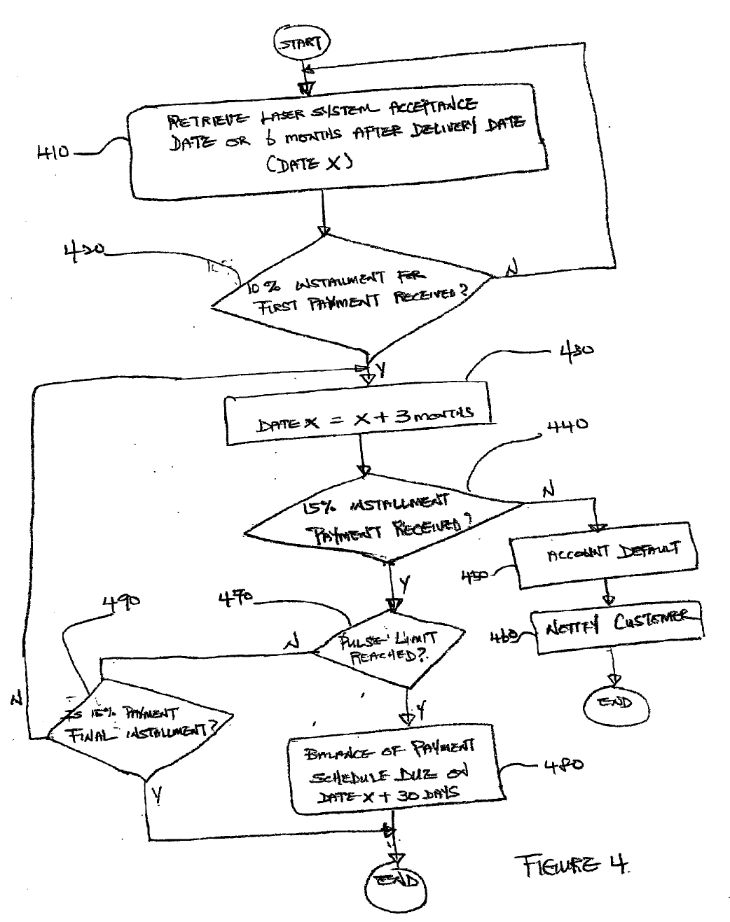

FIG. 4 illustrates a flow chart for generating a predictable cost allocation schedule for a laser system in accordance with one embodiment of the present invention. Referring to FIG. 4, at step 410, the date of the laser system acceptance by the purchaser, or the date on which the initial support service coverage plan expires. In one aspect, for purchasers of new laser systems, the initial support service coverage may include providing on-site field service engineer (FSEs) support for the first six months free of charge to the laser system purchaser.

In particular, the initial support service coverage may include a predetermined schedule for the field service engineer (FSE) support such as on-site support during normal working hours (for example, from 8 am to 5 pm, Monday through Friday), providing availability of the field service engineer (FSE) on site within eight hours during after hour on work days (for example, from 5 pm to 8 am, Monday through Friday), and finally, providing availability of the field service engineer (FSE) on site within 12 hours during non-working hours (for example, from 5 pm on Friday to 8 am on Monday including local and national holidays). Additionally, the initial support service coverage may further include a 24 hour, seven days per week telephone support network with an assured response time of less than two hours.

Referring back to FIG. 4, upon retrieving the date of the laser system acceptance by the purchaser, or the date on which the initial support service coverage plan expires (Date X) at step 410, it is determined whether a 10% installment for the first of the scheduled support service program is received from the laser system purchaser at step 420. If it is determined that the 10% installment payment has not been received from the laser system purchaser at step 420 for the particular laser system which corresponds to the system acceptance date or the expiration of the initial support service coverage date of Date X, then the procedure returns to step 410.

On the other hand, if at step 420, it is determined that the 10% installment payment for the purchaser designated support service program has been received, then at step 430, the variable Date X is incremented by a predetermined amount. In one aspect of the present invention, the predetermined amount may include three months, which corresponds to a quarter in a calendar year. Thereafter at step 440, it is determined whether on Date X (which is incremented by the predetermined amount at step 420) a 15% installment payment for the purchaser designated support service program has been received. If it is determined that the 15% installment payment has not been received at step 440, then at step 450, the purchaser designated support service program is declared to be in default, and the purchaser of the laser system is notified of the default status at step 460.

On the other hand, if at step 440 it is determined that the 15% installment payment has been received from the laser system purchaser, at step 470, it is determined whether the pulse count for the laser system purchased by the customer has reached a predetermined count. It is noted that another countable parameter may be used such as time, accumulated energy input to a discharge of the laser system or number of workpieces processed. In one aspect of the present invention, the predetermined count of the laser system pulse count may be 8 billion pulses. If it is determined at step 470 that the predetermined pulse count has not been reached, then at step 490, it is determined whether the 15% installment payment received at step 440 is the final installment payment for the corresponding purchaser designated support service program. If it is determined at step 490 that the 15% installment payment received from the customer is not the final 15% installment payment for the purchaser designated support service program, then the procedure returns to step 430, and steps 430 through steps 470 are repeated.

On the other hand, if at step 490 it is determined that the 15% installment payment received from the customer is the final 15% installment payment for the purchaser designated support service program, then the procedure set forth in FIG. 4 terminates. Referring back to step 470, if it is determined that the predetermined pulse count is reached, then at step 480, the remaining outstanding balance of the payment schedule for the purchaser designated support service program is determined to be due on 30 days from Date X determined at step 430, and correspondingly, the purchaser is notified of the accelerated due date for the payment of the remaining outstanding balance.

In the manner described above, by generating and providing payment schedule for support services of laser systems to the purchasers with periodic and set amounts, purchasers of laser systems may be provided with a predictable allocation of costs related to supporting the laser systems. Furthermore, by tailoring the periodically scheduled payment date, for example, at every three-month interval, the purchasers may conveniently allocate costs related to supporting the purchased laser system in conjunction with their respective accounting practices.

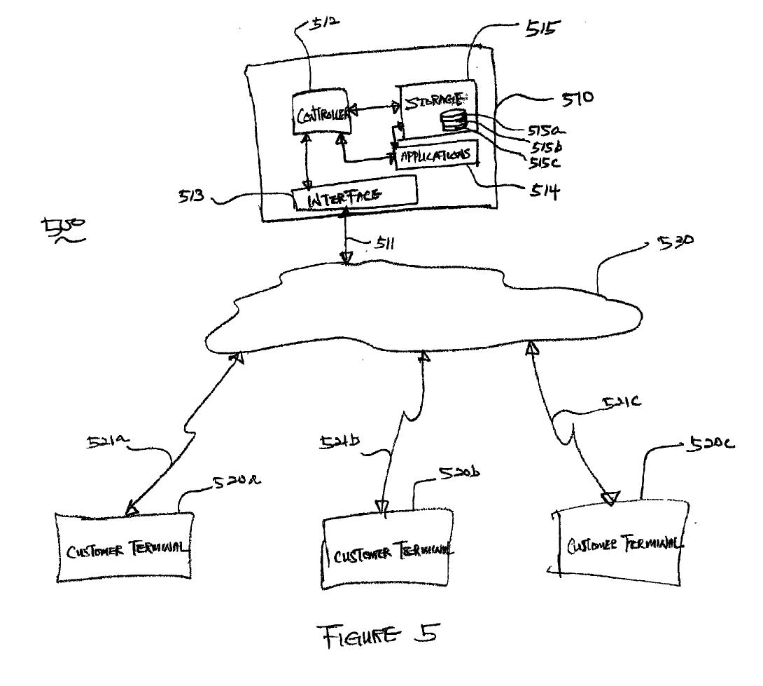

FIG. 5 illustrates a communication network including purchasers of laser systems and the system provider in accordance with one embodiment of the present invention. Referring to FIG. 5, the laser system procurement communication network 500 includes a laser system provider 510 coupled to a communication network 530 via a communication link 511. Also shown in FIG. 5 are a plurality of customers (customer terminals) 520a, 520b, 520c, each coupled to the communication network 530 via a corresponding communication link 521a, 521b, 521c. Each of the plurality of customer terminals 520a, 520b, 520c may include a computer terminal, a facsimile machine, or other communication devices which are capable of receiving and transmitting data from and to the communication network 530. The communication network may include an internet network operating under data protocols such as TCP/IP, and so on. Alternatively, the communication network 530 may include data network enabled for facsimile data transmission.

Referring back to FIG. 5, the laser system provider 510 includes a controller 512, an interface unit 513, a storage unit 515 and an applications section 514. As shown, the interface unit is configured to communicate with the data network 530, and the controller 512 is coupled to the interface unit 513 for controlling the data transmission and reception by the interface unit 513 to and from the data network 530. The controller 12 is further coupled to the applications section 514 which may include application programs or software resident in the laser system provider 510, and which is configured to manipulate the information that is received from the customer terminals 521a, 521b, 521c, and likewise, to transmit data to the customer terminals 521a, 521b, 521c. The storage unit 515 of the laser system provider 510 is coupled to the controller 512 and the applications section 514, and is configured to store data under the control of the controller 512.

In one aspect, the storage unit 515 may include a components database 515a for each laser system available for purchase, a cost allocation schedule database 515b for each purchaser designated support service program, and a customer database 515c. In one embodiment, the components database 515a may be configured to store data corresponding to the components of each available laser system for purchase, including but not limited to, the determined average and/or predicted lifetime for each consumable component, the repair cost estimate for each consumable component, the replacement cost for each consumable component, the availability status of each consumable component, and the estimated delivery time for each consumable component. Furthermore, the cost allocation schedule database 515b may include the scheduled payment date for the purchaser designated support service program, the installment amount corresponding to the scheduled payment dates, the estimated used pulse count corresponding to the scheduled payment dates, and the actual pulse count of the laser system corresponding to the payment dates. Additionally, the customer database 515c may include information corresponding to the purchasers of the laser systems such as contact information, billing information, account information (including account status such as default status, current status and so on), payment history information, component delivery address information, and the type of laser system purchased for each laser system purchaser.

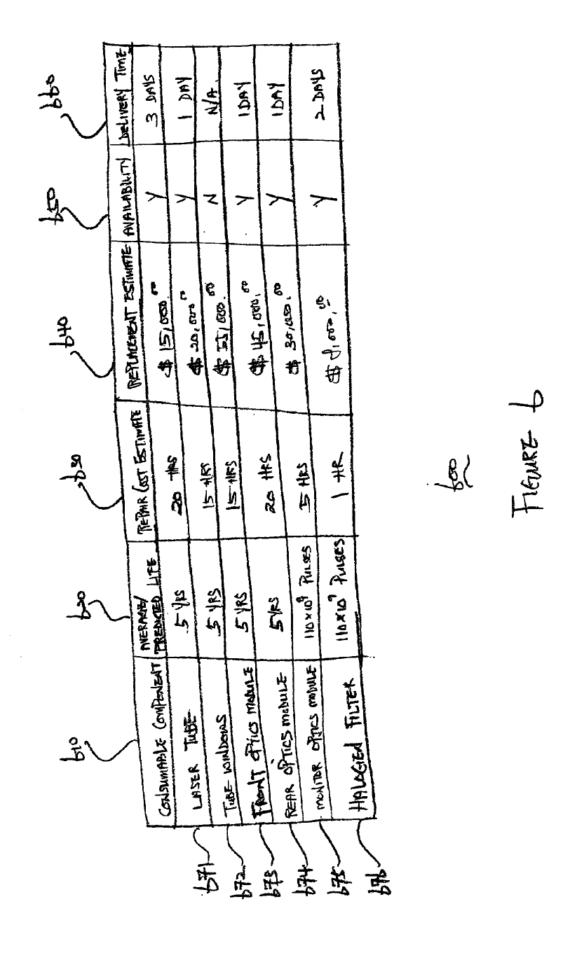

FIG. 6 illustrates a laser system components database 515a of FIG. 5 in accordance with one embodiment of the present invention. Referring to FIG. 6, the consumable components database 515a includes a consumable component field 610, an average/predicted lifetime field 620, a repair cost estimate field 630, a replacement estimate field 640, an availability field 650 and a delivery time field 660. For example, as shown in FIG. 6, for the consumable component laser tube stored in row 671 under the consumable component field 610, the corresponding average/predicted lifetime stored in the average/predicted lifetime field 620 five years, with a repair cost estimate stored in the repair cost estimate field 630 at 20 hours (at, for example, $80 per hours cost), and the replacement component estimate field 640 indicating a laser tube replacement cost estimate at $15,000.00. Furthermore, the availability field 650 indicates that the laser tube is available with a delivery time of three days as shown in the delivery time field 660.

In the manner described above, the components database 515a may be configured to store data corresponding to each consumable component of a laser system, including but not limited to, tube windows (row 672), front optics module (row 673), rear optics module (row 674), monitor optics module (row 675), and halogen filter (row 676), and their corresponding average/predicted lifetime, cost of repair or replacement, availability and the corresponding delivery time. Additionally, it should be noted that while the components database 515a shown in FIG. 6 includes fields for the average/predicted lifetime 620, the repair cost estimate field 630, the replacement estimate field 640, the availability field 650, and the delivery time field 660, in accordance with the present invention, other data relevant to each consumable component may be stored in additional fields in the components database 515a.

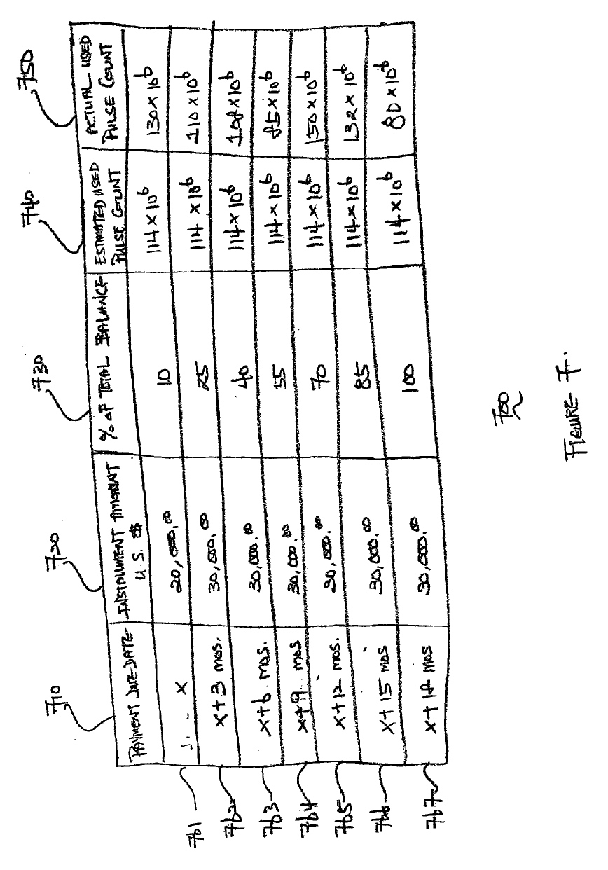

FIG. 7 illustrates the cost allocation schedule database 515b of FIG. 5 for a laser system in accordance with one embodiment of the present invention. Referring to FIG. 7, the cost allocation schedule database 515b includes a payment due date field 710, an installment amount field 720, a percentage of total balance field 730, an estimated used pulse count field 740, and an actual used pulse count field 750. For example, as shown in FIG. 7, for the payment due date x stored in row 761 under the payment due date field 710, the corresponding installment amount stored in the installment amount field 720 is $20,000.00 U.S., with a percentage of total balance stored in the percentage of total balance filed 730 of 10%, and the estimated used pulse count stored in the estimated used pulse count field is 114×106 pulses, and the actual used pulse count stored in the actual used pulse count field is 130×106 pulses.

In the manner described above, the cost allocation schedule database 515b may be configured to store data corresponding to many payment due dates, such as may periodically occur every, e.g., three months from payment due date x, as stored in payment due date field 761. For example, payment due date field 762 may correspond to a payment due date 3 months after payment due date x. Payment due dates 763-767 may respectively correspond to payment due dates x+6 months, x+9 months, x+12 months, x+15 months and x+18 months, as shown at FIG. 7. Additional and/or alternative payment due dates may be included in payment due date field 710 of the cost allocation schedule of FIG. 7, wherein installment amounts at the installment amount field 720, percentages of total balance at the percentatge of total balance field 730, estimated used pulse counts in the estimated used pulse count field 740 and actual used pulse counts in the actual used pulse counts field 750 will be generally varied from those provided in the exemplary cost allocation schedule illustrated at FIG. 7.

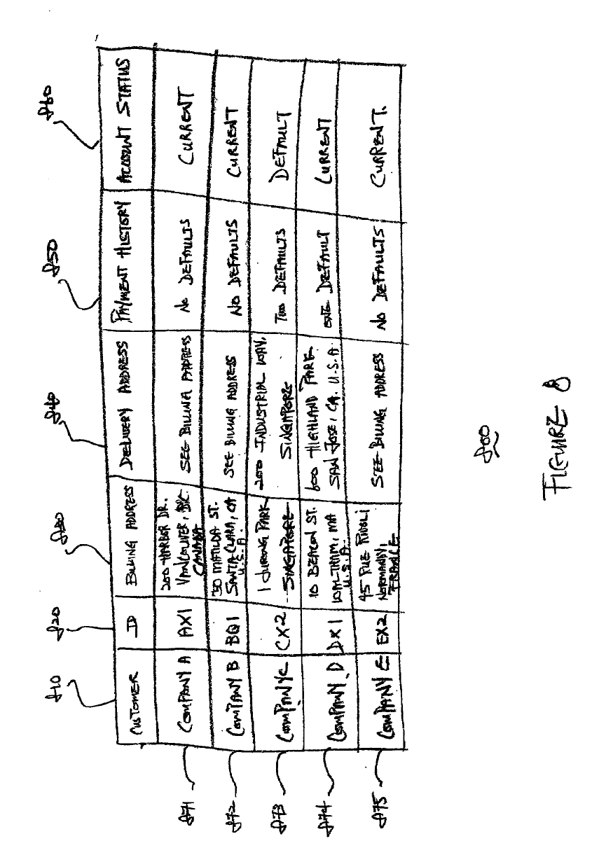

FIG. 8 illustrates a customer database 515c of FIG. 5 in accordance with one embodiment of the present invention. Referring to FIG. 8, the customer database 515c includes a customer field 810, an identification symbol (ID) field 820, a billing address field 830, a delivery address field 840, a payment history field 850 and an account status field 860. For example, as shown in FIG. 8, for the customer company A stored in row 871 under the customer field 810, the corresponding ID stored in the ID field 820 is AX1, having a billing address of 200 Harbor Drive, Vancouver, B.C., Canada stored in billing address field 830 and having a same delivery address as the billing address as shown stored in delivery address field 840. The customer database 515c further shows that the payment history for company A is no defaults as indicated at payment history field 850, and that the account status of company A is current as indicated at account status field 860.

In the manner described above, the customer database 515c may be configured to store data corresponding to each subscribing customer, such as may include company B-company E, as stored in rows 872-875 of the customer field 810 having ID's BQ1, CX2, DX1 and EX2, respectively, stored in the ID field. The billing and delivery addresses of each of companies B-E are also shown in the billing address and delivery address fields 830 and 840, respectively, of the customer database 515c of FIG. 8, as well as are payment histories and account statuses shown at the payment history and account status fields 850 and 860. Other relevant data may be stored in additional or alternate fields of the customer database 515c of FIG. 8, and a very large number of additional customers may be included in the customer database 515c.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

In addition, in the method claims that follow, the operations have been ordered in selected typographical sequences. However, the sequences have been selected and so ordered for typographical convenience and are not intended to imply any particular order for performing the operations, except for those claims wherein a particular ordering of steps is expressly set forth or understood by one of ordinary skill in the art as being necessary.

What is claimed is:

1. A method of allocating predictable costs for consumable items of a laser system, comprising the steps of:
determining a predicted lifetime of one or more components of a laser system in terms of a countable parameter;
estimating costs for the repair and/or replacement of the components in advance of their predicted failure; and
scheduling the costs to be paid at one or more predetermined times.

2. The method of claim 1, wherein the countable parameter is selected from the group of parameters consisting of time, pulse count, accumulated input energy to a discharge of the laser system and number of processed workpieces.

3. The method of claim 1, further comprising the step of ordering in advance one or more replacement components for the one or more components predicted to fail.

4. The method of claim 1, wherein the one or more components includes at least one component from the group consisting of a laser tube, tube windows, a line-narrowing optical component, a line-narrowing module, a monitor optics module, a halogen filter, a pulser module and containers of a laser gas.

5. The method of claim 1, wherein the one or more components includes a line-narrowing module.

6. The method of claim 1, wherein the costs are estimated to be an amount of the countable parameter multiplied by a cost per unit of the countable parameter.

7. The method of claim 6, wherein the countable parameter is selected from the group of parameters consisting of time, pulse count, accumulated energy input to a discharge of the laser system and number of processed workpieces.
